(19) United States
(12) Patent Application Publication
(10) Pub. No.: US 2008/0280565 A1
(43) Pub. Date: Nov. 13, 2008

(54) Indoor coverage estimation and intelligent network planning

(76) Inventors: Vladan Jevremovic, Houston, TX (US); Arash Vakili-Moghaddam, Alpharetta, GA (US); Serge Legris, St-Lazare (CA)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/079,631

(22) Filed: Mar. 28, 2008

Related U.S. Application Data
(60) Provisional application No. 60/920,964, filed on Mar. 30, 2007.

(51) Int. Cl. H04B 17/00

(52) U.S. Cl. 455/67.7

(57) ABSTRACT

A method is described that involves calculating, by processing software program code on a computer, wireless signal coverage within a building for each of multiple floors within the building. The calculating includes accounting for outdoor signal coverage, accounting for building height, accounting for external building wall material and accounting for internal building wall material. Another method is described that involves planning, by processing software program code on a computer, node upgrades to a wireless networking service. The planning includes calculating outdoor node cost as a function of in building wireless network service coverage; calculating indoor node cost as a function of in building wireless network coverage; identifying an in building wireless network coverage value where said outdoor node cost equals said indoor node cost; recommending addition of an outdoor node because current coverage is less than said value; and, recommending addition of an indoor node because current coverage is greater than said value.

### CLAIM TO PRIORITY

This application hereby claims priority to and the benefit of the filing date of U.S. Provisional Application 60/920,964 filed on Mar. 30, 2007 and incorporates that application by reference in its entirety.

### BACKGROUND

Many studies confirm that people spend more than 90% of their day indoors or in transit. Aside from the 25% of the day that is spent resting/sleeping, 18% is spent at an indoor workplace or public venues, 5.5% in vehicles and 7.6% outdoors. In addition, approximately 60% of the voice and data traffic in a day happens during the 18% of the time spent indoors.

Building penetration loss increases exponentially towards building center but the exponent varies greatly with the environment, building type, and building density. Tests conducted in many markets confirm that in most urban areas, the current signal density provides proper radio coverage over only 30-40% of the indoor area. More than 70% of the buildings in urban environment have less than 40% of their indoor area properly covered. On average, an additional 10% of indoor coverage requires a 4-6 dB signal strength increase on the street, resulting in 3-4 times higher site density. Even though they represent only a fraction of the total coverage area, the urban and core urban areas generate 80% of the total voice and data traffic.

As wireless carriers have seen the trend of indoor network traffic increase for voice and data, their interest in deploying the right amount of network nodes for optimal efficiency has also increased. Yet only 10% on average of the carrier's capital expenditure for cell sites is spent on so called “technical sites,” such as in-building distributed antenna systems (DAS).

As wireless carriers have seen the trend of indoor network traffic increase for voice and data, their interest in deploying the right amount of network nodes for optimal efficiency has also increased. Yet only 10% on average of the carrier's capital expenditure for cell sites is spent on so called “technical sites,” such as in-building distributed antenna systems (DAS).

### SUMMARY

A method is described that involves calculating, by processing software program code on a computer, wireless signal coverage within a building for each of multiple floors within the building. The calculating includes accounting for outdoor signal coverage, accounting for building height, accounting for external building wall material and accounting for internal building wall material. Another method is described that involves planning, by processing software program code on a computer, node upgrades to a wireless networking service. The planning includes calculating outdoor node cost as a function of in building wireless network service coverage; calculating indoor node cost as a function of in building wireless network coverage; identifying an in building wireless network coverage value where said outdoor node cost equals said indoor node cost; recommending addition of an outdoor node because current coverage is less than said value; and, recommending addition of an indoor node because current coverage is greater than said value.

### BRIEF DESCRIPTION OF THE DRAWINGS

The present invention is illustrated by way of example and not limitation in the figures of the accompanying drawings, in which like references indicate similar elements and in which:

FIG. 1 illustrates a high level depiction of an exemplary in-building coverage analysis module

FIG. 2 illustrates an exemplary architecture of the in-building coverage analysis module of FIG. 1.

FIG. 3 shows an exemplary flow/structure for calculating internal building losses.

FIG. 4 illustrates an outer contour of an exemplary building.

FIG. 5 illustrates the contours of outer and inner walls of the building shown in FIG. 4.

FIG. 6 illustrates an exemplary building height loss coefficient as a curve.

FIG. 7 illustrates exemplary building penetration loss, color-coded in grayscale.

FIG. 8 shows an exemplary representation of an Outdoor Signal Layer.

FIG. 9 illustrates a measured data layer with buffers around exemplary measured routes.

FIG. 10 illustrates an exemplary flow/structure for intelligent network planning.

FIGS. 11a-11c represent different options for illustrating an aggregation area.

FIG. 12 illustrates an exemplary curve fitting diagram.

FIG. 13 illustrates an exemplary outdoor node trend line cost curve.

FIG. 14 illustrates an exemplary outdoor node cost/coverage curve.

FIG. 15 illustrates an exemplary indoor node cost/coverage curve.

FIG. 16 illustrates an exemplary outdoor vs. indoor node cost/coverage curve.

FIG. 17 illustrates Net Present Value (NPV) vs. indoor coverage in an exemplary market.

FIG. 18 illustrates an embodiment of computing system

### DETAILED DESCRIPTION

### Indoor Coverage Estimation

An “in-building” coverage analysis module of an indoor coverage estimation system is described. According to at least one embodiment, the coverage module will take certain inputs (“layers” or “models”) describing one or more buildings and information about the outdoor wireless signal coverage to produce an output which has estimated signal levels within the one or more buildings. The output, in one embodiment is geo-coded. The output(s) may use any type of desired coordinate system and may also be displayed graphically on a computer screen (e.g., by mapping each graphical node to a computed value representing amount of received energy, amount of energy degradation, and whether the node represents acceptable coverage).

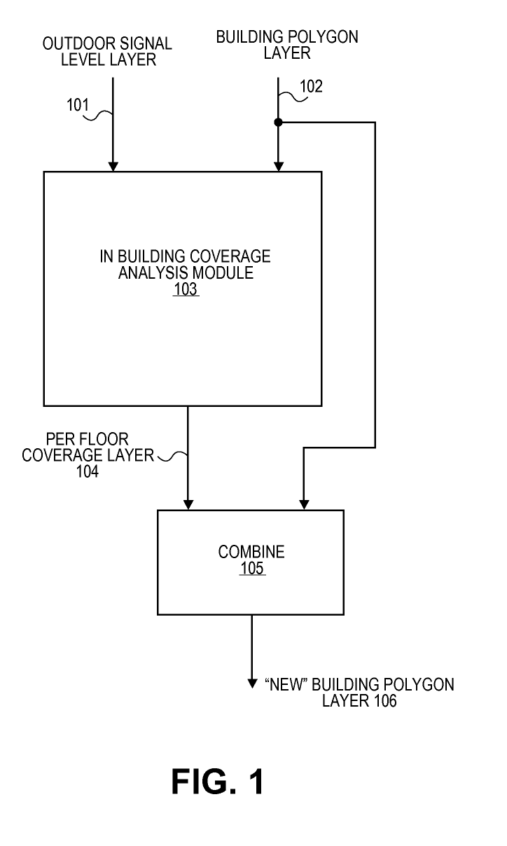

Referring to FIG. 1, a set of inputs 101, 102 are presented as geo-coded sets of matrices. Such inputs 101, 102 are referred to as “Layers.” More generally, “Layers” may be thought of as “models”. For simplicity this description will mostly use the term Layers. Each Layer may be represented with respect to a geographic coordinate system and datum (i.e. Coordinate System of Latitude/Longitude, and datum of WGS-84), or an alternative reference system.

Layers may be implemented in a number of ways. According to at least one approach a layer may be implemented as a vector image represented by polylines, polygons, or regions. Alternatively a Layer may be represented as raster (bitmap) images representing geographical grids. Grids are made up of regularly spaced square cells arranged over a given area. Each cell has a node, which is a point located at its center. Each cell can be given a value and a in one embodiment a color representing the value. As described in more detail further below, one approach accepts the inputs 101, 102 as vectors but presents the output(s) 104 as a raster.

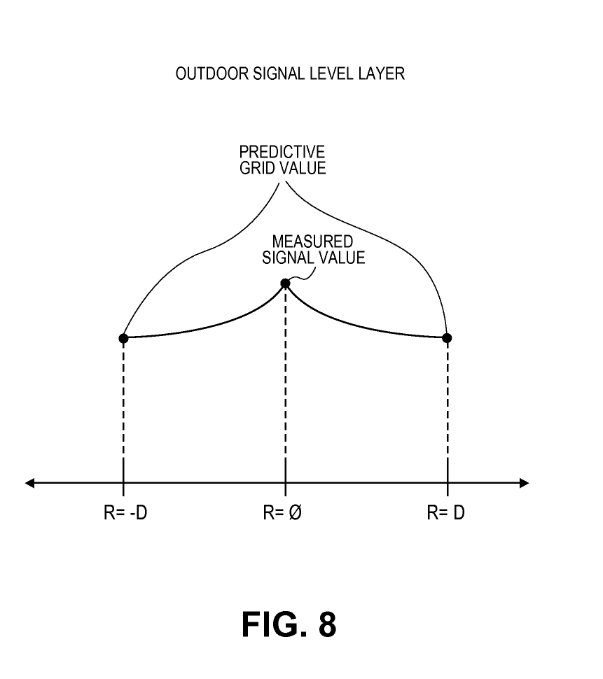

With inputs 101, 102 and outputs 104 represented as Layers, available commercial computer applications or a developed application capable of geo-analysis can easily represent these inputs and outputs graphically on a computer screen and also derive statistics when relating one Layer to another. According to one approach, depicted in FIG. 1, input Layers include: Outdoor Signal Layer 101 and Building Polygon Layer 102. An optional input Layer may include a Measured Signal Layer 103 which is discussed in more detail below with respect to FIG. 8. The output Layers 104 may include one or more models, such as a Per Floor Coverage Layer 104, describing the acceptable coverage area within the various building(s) entered at input 102 amongst their various floors.

In one embodiment, additional “ancillary” output Layers/models are generated as part of the internal calculations performed by the in-building analysis module 103. Examples include (not depicted in FIG. 1): a Per Floor Signal Layer, an Internal Walls Layer, an Indoor Outdoor Signal Layer, and Building Loss Layer(s). Each of these is described in more detail further below. A New Building Polygon Layer output 106 may also be produced by combining the Per Floor Coverage Layer 106 and the Building Polygon layer 102. Generation of the New Building Polygon Layer 106 is also described in more detail below.

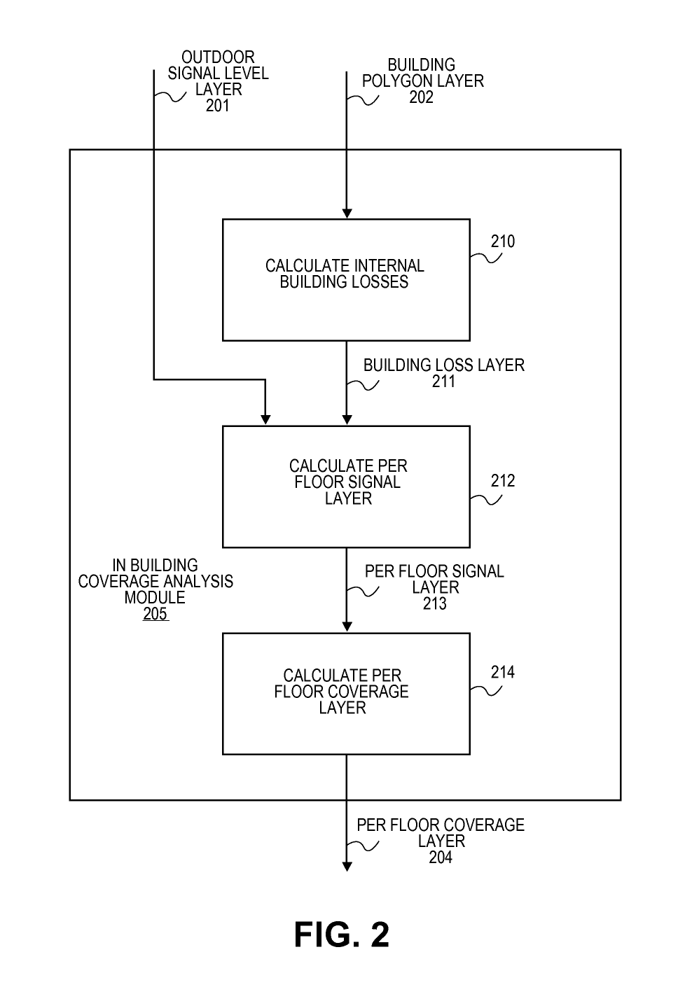

FIG. 2 shows an exemplary “high-level” view of the inner structure/flow of the in-building coverage analysis module 103 of FIG. 1. As observed in FIG. 2, the in-building coverage analysis module 205 may perform the following calculations: 1) the calculation of internal building losses 210 based on the Building Polygon Layer 202 to form a Building Loss Layer 211; 2) the calculation 212 of signals within the various buildings based on the Outdoor Signal Layer 201 and the Building Loss Layer 211 to form a Per Floor Signal Layer 213; and, 3) the estimation 214 of signal coverage within the various buildings to produce the Per Floor Coverage Layer output 204. These are described in more detail below.

As observed in FIG. 2, the calculation of internal building losses 210 produces the Building Loss Layer 211 which, in an embodiment, is a grid representing the varying in-building penetration signal loss values at each grid location on each floor of the building(s) described by the Building Polygon Layer 202. Once the Building Loss Layer 211 is produced, the Per Floor Signal Layer 213 is calculated 212 from the Building Loss Layer 211 and the Outdoor Signal Layer 201. In an embodiment, as described in more detail below, the Outdoor Signal Layer 201 is a description of the signal strength on the street level and the Building Loss Layer 211 accounts for variation in indoor penetration loss as a function of building height. Therefore a straightforward combination of the Building Loss Layer 211 and the Outdoor Signal Layer 201 results in a good approximation of the signal level at all floors within all buildings. Finally, the Per Floor Coverage Layer(s) 204 is derived. The Per Floor Coverage Layer output 204 shows the regions of the acceptable coverage inside a building for each floor of every building. Here, calculating the Per Floor Coverage Layer 204 involves screening the Per Floor Signal Layer against a threshold of acceptable vs. unacceptable.

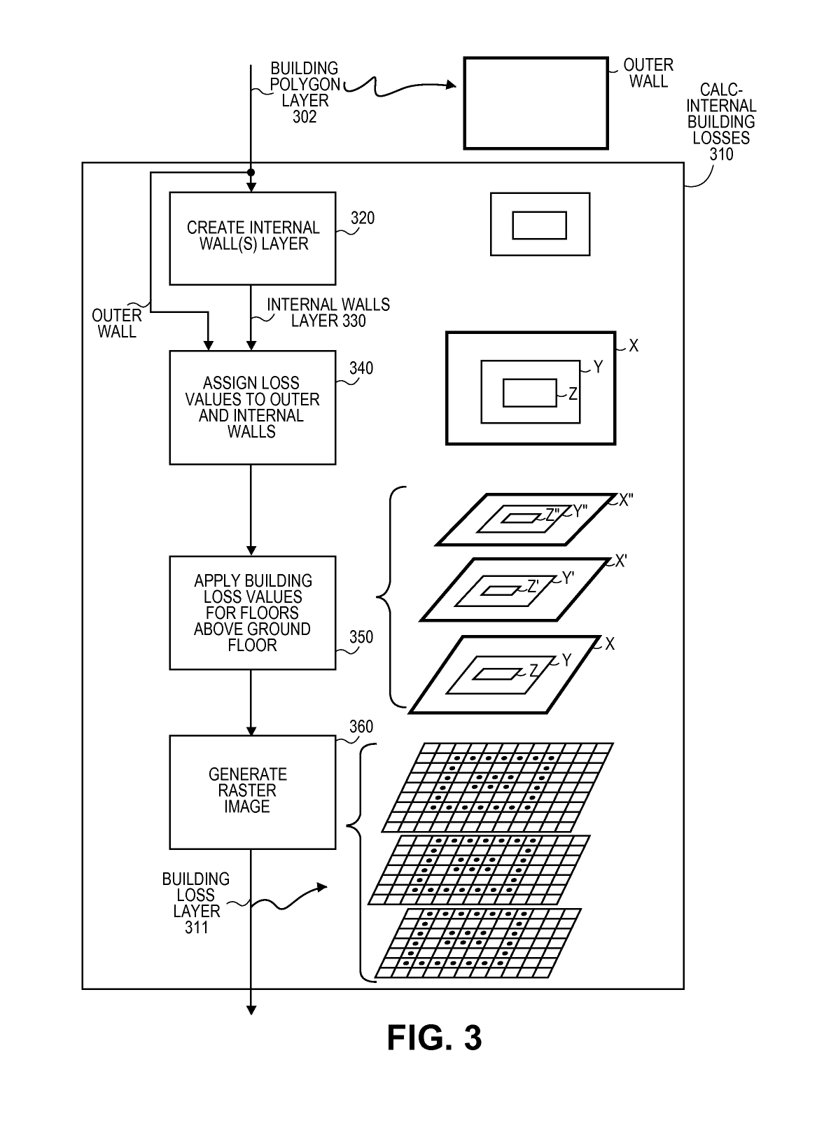

FIG. 3 shows an exemplary view of the structure/flow 310 for the calculation of the internal building losses 210 as depicted in FIG. 2. In an embodiment, the Building Polygon Layer 302 has vector images representing physical building structures as well as associated data per each complete building object. This data generally will contain but not be limited to the height of each complete object representing the physical structure (“building”) in a city or area under study. The outline of each building object in this layer 302 represents the outer wall of a building. As observed in FIG. 3, the input Building Polygon Layer 302 is used as a basis for constructing the Building Loss Layer 311 in one embodiment according to the following process:
I) Create 320 vector images representing closed poly-lines representing internal walls of each building known as Internal Walls Layer 330.
II) Associate 340 building penetration loss values at internal and external walls;
III) Apply 350 Building Penetration loss adjustments for floors above the ground level; and
IV) Generate 360 a raster image grid to form Building Loss Layer 311 by transforming all the geo-coded objects from a vector form image to a raster image and interpolating values for grid nodes between the known grid values based on the Internal Walls Layer to arrive at the Building Loss Layer. The Building Loss Layer 311 will then represent the estimation of the amount of signal loss an Outdoor signal would experience at that each grid location inside a building. The side of the grid cells is adjustable by the user and uniform across the grid.
   Therefore, the building penetration loss is the value associated to each square cell. The output of the process are building penetration loss layers at Level 1, 2, 3, . . . n, where in is the highest floor of the tallest building in the city/region under analysis.

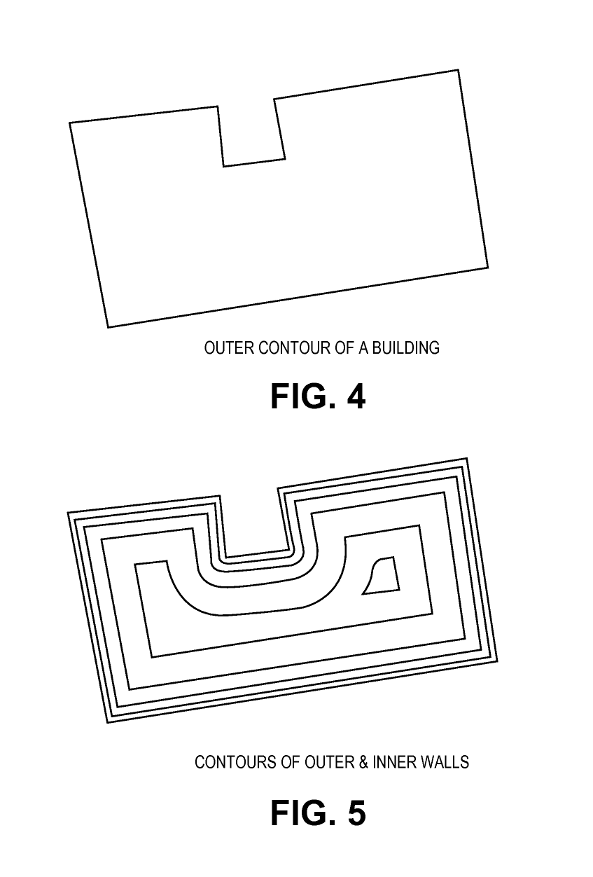

As observed in FIG. 3, the starting point for calculating the Building Loss Layer 311 is by first creating 320 the Internal Walls Layer 330. In the particular embodiment of FIG. 3, the Building Polygon Layer 302 models the outer (external) walls of buildings, as shown in FIG. 4, which represents a typical building contour. Location and number of inner walls are not explicitly known, but are instead approximated by a series of concentric circles inside a building, as shown in FIG. 5. The exact number of internal walls, as well as their distance from the outer wall is a function of building size and shape. This function can be assigned the same for all buildings in the city/region, or modified per individual building or building type.

Also as observed in FIG. 3, each wall in a building is assigned a unique penetration loss value 340. In an embodiment, the following multi-wall COST231 formula from C. Tornevik, J-E Berg, F Lofse “900 MHz propagation measurements and path loss models for different indoor environments” Proc IEEE VTC '93, New Jersey, USA, 1993 is used,

$$L = {L}_{FS} + {L}_{c} + {\sum }_{i = 1 , I}^{ } {k}_{wi} {L}_{wi} + {k}_{f}^{[ \frac{{k}_{f} + 2}{{k}_{f} + 1} - b ]} {L}_{f} \qquad ( 1 )$$

### Where

L_{FS}=free space loss between transmitter and receiver
L_{c}=constant loss
k_{wi}=number of penetrated walls of type i
k_{f}=number of penetrated floors
L_{wi}=loss of wall type i
L_{f}=loss between adjacent floors
b=empirical parameter
I=number of wall types
   In one embodiment the formula is modified as follows:
L_{FS}=0 (because the signal strength just outside the outer wall is known)
k_{f}=0 (assume that the signal does not spill to the floor above or below)
   Then the resultant equation is:

L=L_{C}+Ak_{w1}+Bk_{w2}+k_{w3} (2)

where:
Lc: a tunable value to adjust based on empirical measurements to account for the outer wall material and/or thickness. Default value is 0 for buildings with steel/windows, brick and brownstone buildings have Lc >0.
K_{w1}: Light (internal) wall penetration loss coefficient. Kw1 is a positive number;
K_{w2}: Heavy (external & internal) wall penetration loss coefficient. Kw2 is a positive number;
K_{w3}: Building height coefficient loss (see FIG. 3). K_{w3} can be either positive or negative;
A: Number of light walls, including the wall for which penetration loss is being calculated;
B: Number of heavy walls, including the wall for which penetration loss is calculated.
   Penetration loss coefficients Kw1 and Kw2 can be assigned for all buildings in the city/region, per individual building, or per building type.

As an example, for a building that has one external wall and three light internal walls, the penetration loss at the second concentric internal wall on the first level will have A=2, B=1. The penetration loss at the third concentric internal wall will have A=3, B=1.

In an embodiment, the loss values that are assigned to the outer and inner walls are viewed as being at the ground level. However, outdoor signal varies with elevation due to multiple factors. One factor is building clutter; as the receiver rises above the ground level, there are fewer and fewer obstacles between the transmitting antenna at macro base station antenna and receiver. The second factor is transmitting antenna radiation pattern, which is generally optimized to give maximum radiation at the street level. Therefore, an adjustment 350 to the ground level building penetration loss is needed to account for the loss variation at upper floors.

At first, building penetration loss decreases as the receiver moves above the clutter and closer to the height of the base station transmitting antenna. Once the receiver goes above the height of the transmitting antenna, it gradually starts losing the signal. This corresponds to an increase in penetration loss.

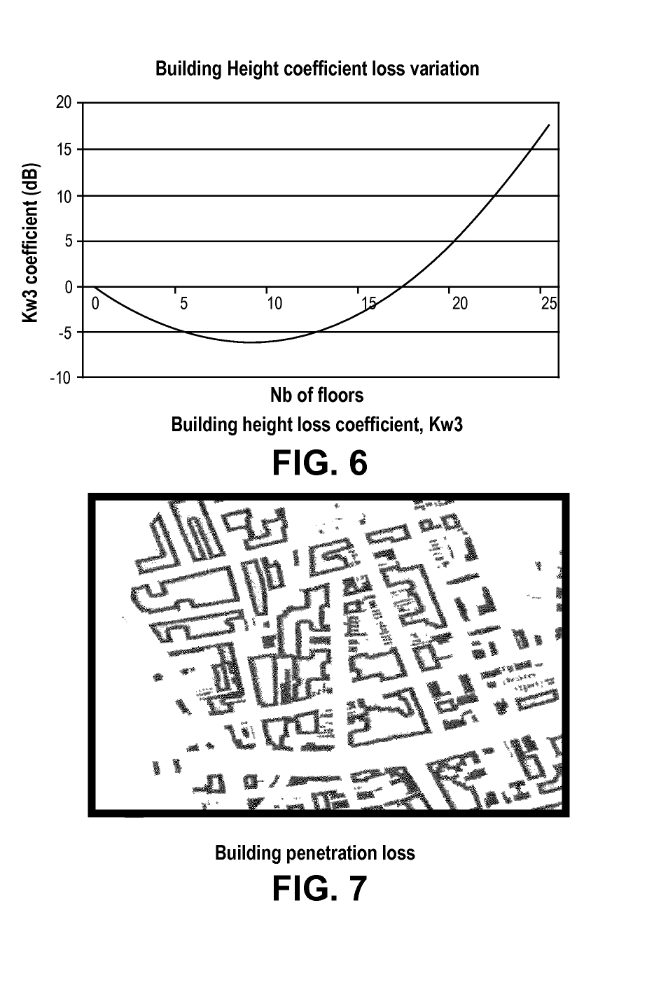

To account for this variation in building penetration loss, in one embodiment, the building height coefficient (Kw3) is expressed as a function of number of floors in a building. An example is shown in FIG. 6. The particular curve of FIG. 6 is based on E. F. T. Martijn and M. H. A. J. Herben, “Characterization of Radio wave Propagation Into Buildings at 1800 MHz”, IEEE Antennas and Wireless Propagation Letters, Vol 2, 2003 (“Martijn” et al.) and additional analysis. The Martijn et al. reference indicates that penetration loss decreases 1-2 dB per floor for floors 2-12. Experimental results indicate that past floor 12 penetration loss starts to increase. Due to antenna pattern shape and other factors, calls generally can not be originated above the 25^{th} floor. This behavior was therefore modeled by adding 2-3 dB penetration loss increase per floor for floors 13-25.

Referring back to FIG. 3, building penetration loss values calculated for the internal and external walls at the ground floor 340 and modified by the building height 350 represent loss values assigned at the outer wall and at concentric internal walls for the first or each floor in a building.

The next step is to create 360 a grid layer of equidistant square cells for each floor, and assign penetration loss values at each cell node (grid point). Penetration loss values at grid points are calculated by interpolating known penetration loss values at building walls. Interpolation may be done for each floor separately. The output of this process is the Building Loss Layers 311; there may be as many grid layers as the highest number of floors in a building in the city/region under analysis. All areas outside buildings are assigned null building penetration loss value. An example of color coded penetration loss grid is given in FIG. 7.

FIG. 8 pertains to an optional process for using actual measured data to produce the Outdoor Signal Layer 101 of FIG. 1. If an optional Measured Signal Layer referred to as “measured data” is used, the system combines that layer which may be obtained as a result of drive test coverage and combine it with a “prediction grid” to produce an Outdoor Signal Layer 101. The “predictive grid” can be generated via a number of commercially available software packages, or by other means by a person skilled in this art. It is assumed in one embodiment that both input files, i.e., the predictive grid and the Measured Signal Layer are geo-coded as is the nature of all Layers explained before, and contain information about at least one radio coverage parameter, such as Received Signal (Rx), Signal Quality (RxQual), Frame Error Rate (FER), etc.

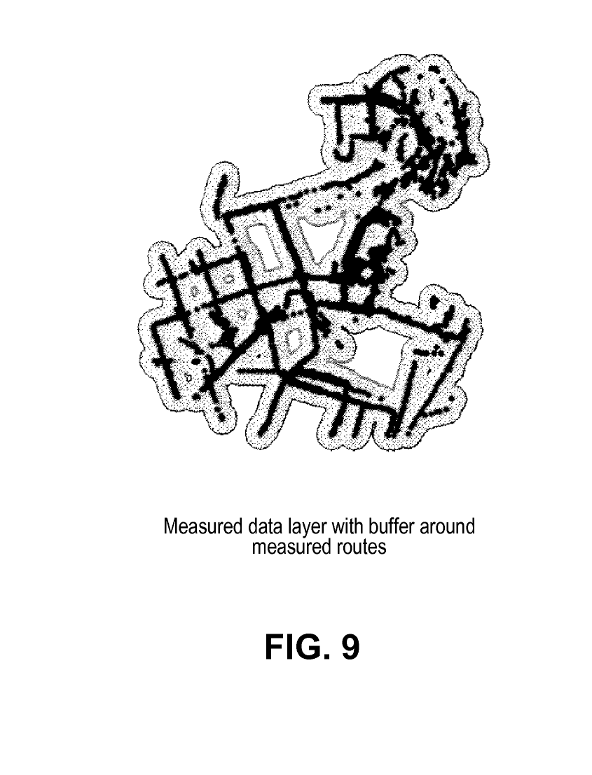

It is assumed that the measured data consists of radio parameters recorded at street level along streets, roads, highways and other drive routes. Buffers are created around drive test routes as observed in FIG. 9. Referring back to FIG. 8, distance D is an input variable assigned for all drive routes in the city/region, and 2*D represents the width of the buffer.

The output combined coverage grid is calculated by combining the two input files within the buffer. At the center of the buffer (R=0), the output grid file is equal to the measured data. At the edge of the buffer (R=D), the output grid is equal to the prediction grid. Within the buffer (0<R<D), the output grid is a linear combination of the two, where R is a variable representing distance from center of the buffer, i.e. drive test route. Outside the buffer, the output grid is equal to the prediction grid.

As an example, assume that radio parameter of interest is Received Power (Rx). The output file grid would be calculated as:

Rx(out)=[Rx(prediction)−Rx(measured)]*R/D+Rx(measured) if 0<R<D

Rx(out)=Rx(prediction) if R≧D

where:
Rx(prediction) is Rx value of prediction grid layer;
Rx(measured) is measured data along drive routes;
D is one half of the buffer width;
R is variable distance from the center of a buffer to the edge.
   Similar formula may be used for every other radio parameter in the network, such as RxQual, FER, etc.

Referring back to FIG. 1, the last step is to create 105 the New Building Polygon Layer 106. This layer is an exact copy of Building Polygon Layer 102, except it is updated with information from the Per Floor Coverage Layer(s) 104 by extracting the area in the desired unit of each floor that is covered. In one embodiment, every floor of every building includes in its matrix the coverage area and thus the percentage of available coverage per floor calculated as (total area of coverage object/total area of floor object).

An alternate approach to creating the Per Floor Signal Layer 104 of FIG. 1 can speed up the processing time and reduce the amount of generated data by eliminating some intermediate outputs. Referring to FIGS. 2 and 3, these modifications affect Calculating Building Losses 210, 310. Specifically, blocks 340, 350, and 360 are only completed for the first floor. Then, for calculation 212 of the Per Floor Signal layer 213 of FIG. 2, layers are created for each floor (i.e. Layer 1 to N) where each layer only includes a layer for a respective floor number. Initially the data in those layers represents only the values for the first floor (e.g., the first floor data is replicated N times). Then, during calculation 214 of the Per Floor Coverage Layer 204, for each respective floor, the system adjusts the acceptable coverage threshold and thus the coverage area by a value representative of the applied building loss values 350 for floors above ground level. As explained above, the same result is reached for the Per Floor Coverage Layer 104 for each floor, however, the calculation 310 of the building losses is modified such that we only have a Building Loss Layer 311 for the first floor.

### Intelligent Network Planning

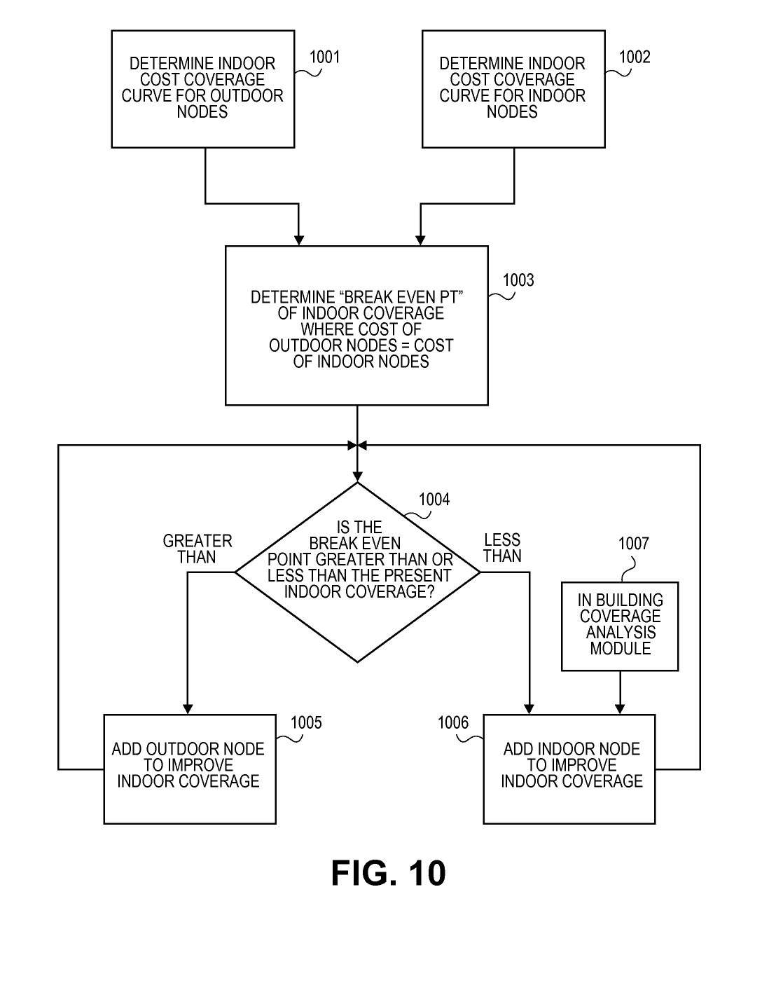

FIG. 10 provides an exemplary structure and flow of an intelligent network planning module that uses outdoor and indoor node cost/coverage curves to assess the cost effectiveness of adding new outdoor and/or indoor nodes to improve inbuilding coverage on a market level while maximizing Return on Investment (ROI). In a market where there are no or very few outdoor nodes, it is initially cost effective to use outdoor nodes to improve coverage in buildings. However, the cost goes up exponentially as more and more outdoor nodes are added. On the other hand, using indoor nodes to improve coverage in buildings has significant startup costs, but the cost flattens out as the percentage of indoor coverage increases.

As observed in FIG. 10, the identification 1003 of a city/region-specific value of indoor coverage percentage (“break even point”) where the costs of deploying outdoor nodes is equal to the cost of deploying indoor nodes assists in determining the optimum node deployment with the highest ROI. Specifically, if the percentage of indoor coverage is below this value, it is economical to add more outdoor nodes to improve the coverage 1005 until this point is reached. If the percentage of indoor coverage is above this value, it is not economical to sad further outdoor nodes; instead, individual buildings should be identified for indoor node deployment 1006. As an example, outdoor nodes deployed in a city/region may be in the form of macro base station (BTS), mesh network elements, outdoor high power repeaters, etc. Examples of indoor nodes are pico cells, distributed antenna systems (DAS), low power repeaters, etc.

Two initial steps are performed to generate the outdoor and indoor cost/coverage curve: an outdoor node cost/coverage curve calculation 1001 and an indoor node cost/coverage curve calculation 1002.

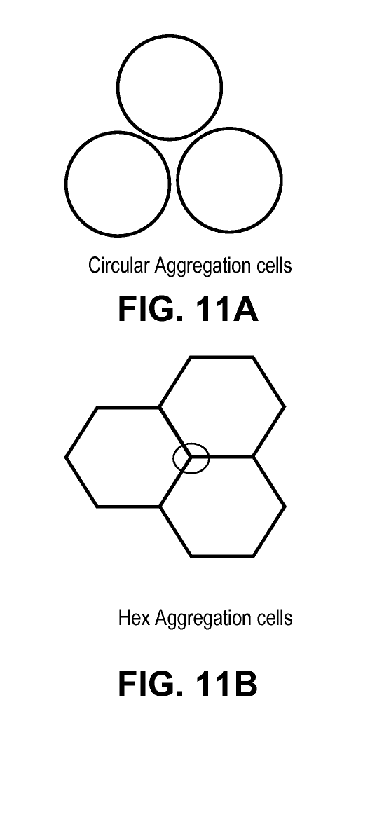

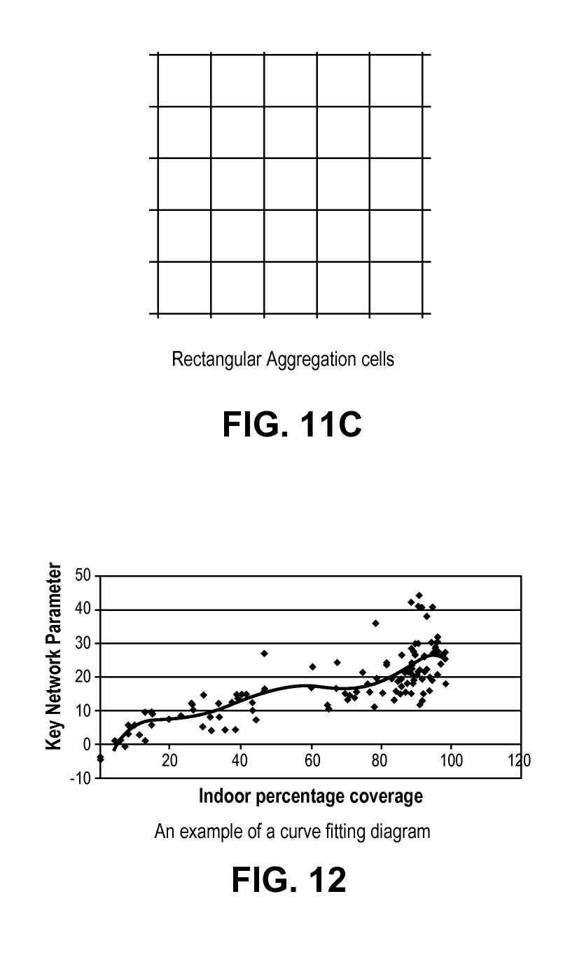

The aggregation area of analysis can be created via an existing GIS tool, or computer program. This aggregation area may be represented as either a vector or raster image. The aggregation area consists of cells, and each cell in the aggregation area can be of any shape. As an example, those cells can be circles (FIG. 11a), hexagons (FIG. 11b), rectangles (FIG. 11c), or other shapes not shown.

The size of the aggregation cell described above may be comparable to coverage area of an outdoor node in a city/region under study. A table is generated with aggregated radio and network parameters (e.g., Rx, RxQual, Frame Error Rate—FER, Minutes of Use—MOU, number of dropped calls, etc. per aggregation cell) grouped and associated with the ratio of inbuilding area over acceptable inbuilding coverage area (also known as indoor coverage percentage) over an aggregated cell.

The values of network parameter of interest versus indoor coverage percentage are plotted with the goal of approximating discrete values of the parameter of interest as a function of indoor coverage percentage into a continuous function. One possible method of doing so is to apply one of many curve fitting methods, such as that illustrated in FIG. 12. After the continuous curve is produced, the cost of an outdoor node equipment and installation are factored in.

In one embodiment, basic assumptions are: a) if there are no outdoor nodes anywhere in the aggregated cell, that cell still has some residual indoor coverage due to outside node coverage, and b) if there is an outdoor node in the center of the aggregated cell, that cell has high percentage indoor coverage, but still less than 100%. In this example, it is assumed that the full node equipment and installation cost are required to achieve 90% inbuilding coverage. Then those costs are applied to corresponding indoor coverage percentage values observed in FIG. 12 and interpolated.

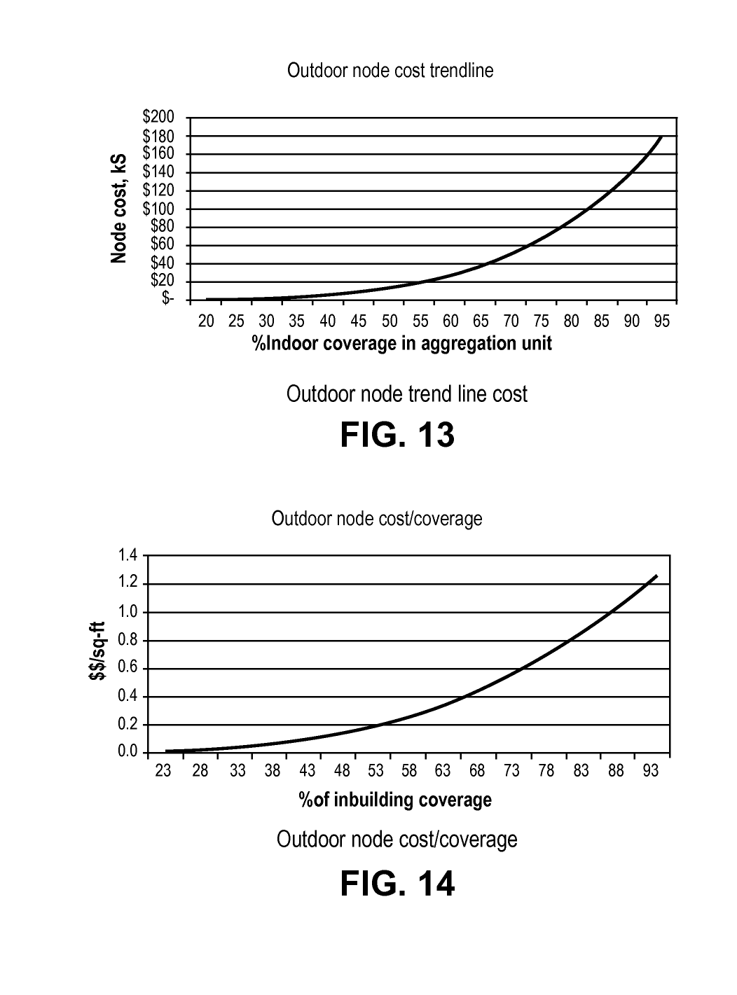

For example, in an embodiment, in order to generate the curve of FIG. 12 a key network parameter is chosen—e.g., Received Signal Strength Indicator RSSI. RSSI vs. indoor percentage coverage is then plotted for all tiles. Since RSSI is a negative value, a constant is added to RSSI to make all values positive. Then a curve fit to these scaled RSSI values against indoor percentage coverage is performed. The solid curve in FIG. 12 is the product of that curve-fitting. The curve in FIG. 13 is then calculated as:

y(x)=f(x)*full cost of outdoor node/f(90%).

### Where:

y(x) is the cost of outdoor node.
x is indoor coverage percentage.
f(x) is the solid curve in FIG. 12.
f(90%) is the value of the solid curve at 90% indoor coverage (taken from FIG. 12).
   When x=90% we get:

y(90%)=f(90%)*full cost of outdoor node/f(90%)

therefore y(90%)=full cost of outdoor node which is the assumption outlined in the procedure: an outdoor node located in the middle of a tile will contribute to 90% indoor coverage in that tile.

The result is an outdoor node trend line cost curve shown in FIG. 13. In an embodiment, the outdoor node trend line cost curve is used as, or is used as a basis for generating, the indoor cost coverage curve for outdoor nodes 1001 referred to in FIG. 10.

In one embodiment, the indoor cost coverage curve for outdoor nodes 1001 is expressed in cost per sq. ft. To calculate the cost of outdoor node coverage per square foot of a covered building as a function of percentage coverage, the ratio of the trend line cost curve above with normalized size (in sq-ft or sq-m) of aggregation cell needs to be taken at various inbuilding percentage coverage levels. An example is illustrated in FIG. 14.

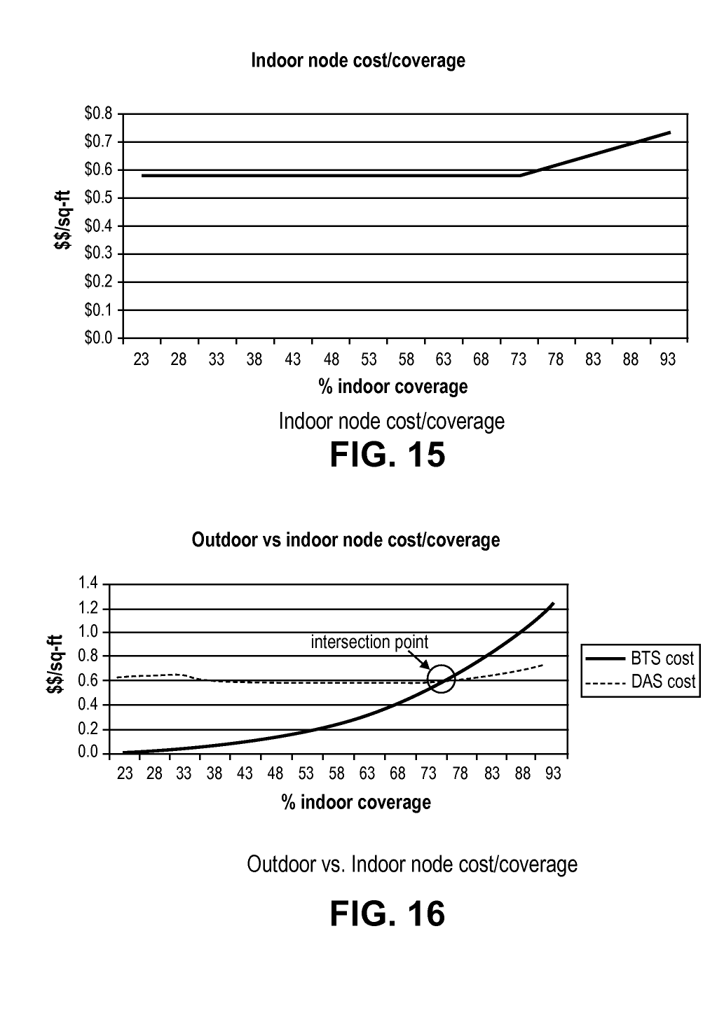

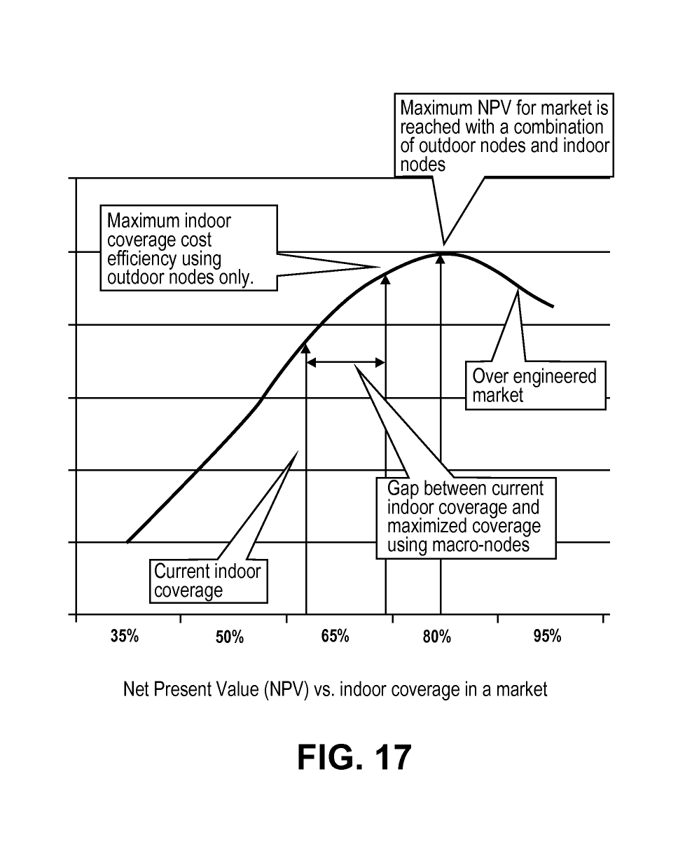

In an embodiment, referring back to FIG. 10, the indoor node cost/coverage curve 1002 is calculated by:
(a) determining the minimum size of a building (in sq-ft) in a market for which indoor node may be considered to improve inbuilding coverage;
(b) calculating the average size of a building in a market, excluding the buildings that are smaller than the minimum size determined in (a); and
(c) calculating the cost of indoor node installation if it were to cover a fraction of the of the average building determined in (b), then dividing the cost by the building size.
   Step c is repeated for various percentages of floor coverage for the average building. FIG. 15 illustrates an exemplary indoor cost/coverage curve.

By combining information from FIGS. 14 and 15, for example, the point of intersection of the two curves in a city/region can be determined. This corresponds to the determination 1003 of the “break even point” referred to in FIG. 10. An exemplary depiction of the combination of FIGS. 14 and 15 is presented in FIG. 16. In this particular example, at 75% indoor coverage in a city/region, the cost of adding new outdoor nodes is equal to the cost of using indoor nodes to improve the coverage.

Based on the knowledge of the current indoor coverage percentage in the market, which can be calculated from the indoor/outdoor coverage maps, and the break even point where outdoor and indoor deployment costs are equal as shown in FIG. 16, it can be deduced whether it is economically viable to add more outdoor nodes in the market from the indoor coverage perspective. Specifically, referring to FIG. 10, if the “break even” point is greater than the current indoor coverage percentage in a city/region, then more outdoor nodes may be added to improve indoor coverage 1005, until the “break even” point is reached. If the “break even” point is lower than the current market level indoor coverage, then targeting individual buildings for indoor node deployment leads to higher ROI for a network operator 1006.

In the case where the break even point is greater than the current indoor coverage percentage in a city/region, aggregate area cells with average indoor percentage coverage that have lower indoor percentage coverage than the break even point are identified as good candidates for outdoor node deployment. Those area cells are in one embodiment further examined for key network and radio parameters (Rx, RxQual, FER, MOU, dropped calls, etc), as well as business indicator parameters (number of employees, number of buildings, etc.), and other parameters of interest such as building density, number of buildings per aggregate cell, their orientation and size, distance from the nearest outdoor node, etc. A decision is then made which aggregate cells are most desirable for outdoor node deployment.

In the case where the break even point is lower than current indoor coverage percentage in a city/region, individual buildings are examined for indoor node deployment. The indoor/outdoor coverage maps also have information about percentage of inbuilding coverage for each building in a city/region. A decision is made as to a minimum acceptable inbuilding coverage percentage in a building, and buildings that meet that requirement are excluded from consideration for indoor node deployment. Here, an inbuilding coverage analysis tool 1007 may be used, such as the in building coverage module previously discussed with reference to FIGS. 1 through 9. Also, additional factors may be factored in to identify potential candidate buildings, such as building square footage, number of employees, the type of businesses that reside in the building (Fortune 500, etc.), the number of existing wireless subscribers, etc. Based on those factors, a recommendation is then made where to deploy indoor nodes.

### System Implementation

Processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.) or may be compiled directly into object code.

According to various approaches the abstract execution environment may convert the intermediate form program code into processor specific code by, 1) compiling the intermediate form program code (e.g., at run-time (e.g., a JIT compiler)), 2) interpreting the intermediate form program code, or 3) a combination of compiling the intermediate form program code at run-time and interpreting the intermediate form program code. Abstract execution environments may run on various operating systems (such as UNIX, LINUX, Microsoft operating systems including the Windows family, Apple Computers operating systems including MacOS X, Sun/Solaris, OS/2, Novell, etc.).

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

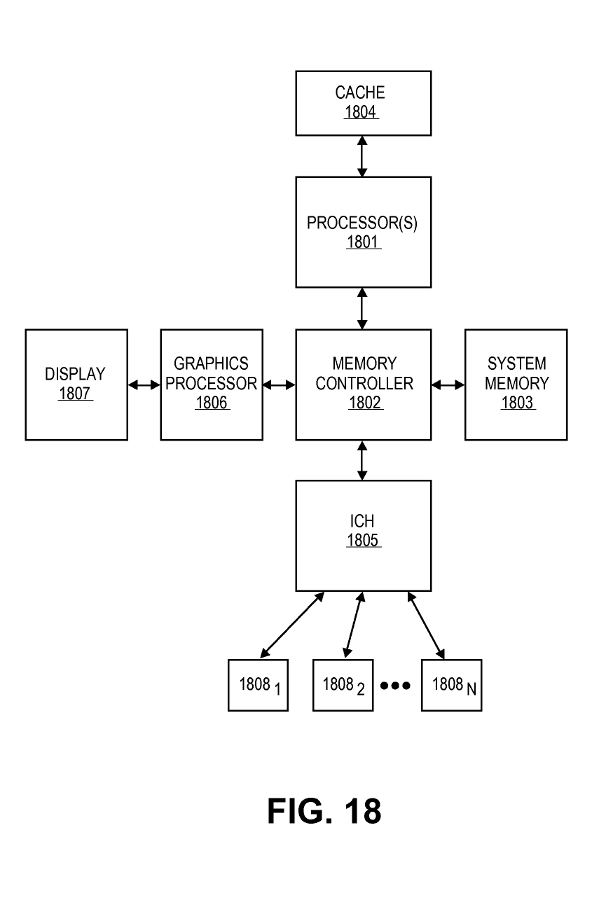

FIG. 18 shows an embodiment of a computing system (e.g., a computer). The exemplary computing system of FIG. 18 includes: 1) one or more processors 1801; 2) a memory control hub (MCH) 1802; 3) a system memory 1803 (of which different types exist such as DDR RAM, EDO RAM, etc,); 4) a cache 1804; 5) an I/O control hub (ICH) 1805; 6) a graphics processor 1806; 7) a display/screen 1807 (of which different types exist such as Cathode Ray Tube (CRT), Thin Film Transistor (TFT), Liquid Crystal Display (LCD), DPL, etc.; 8) one or more I/O devices 1808.

The one or more processors 1801 execute instructions in order to perform whatever software routines the computing system implements. The instructions frequently involve some sort of operation performed upon data. Both data and instructions are stored in system memory 1803 and cache 1804. Cache 1804 is typically designed to have shorter latency times than system memory 1803. For example, cache 1804 might be integrated onto the same silicon chip(s) as the processor(s) and/or constructed with faster SRAM cells whilst system memory 1803 might be constructed with slower DRAM cells.

By tending to store more frequently used instructions and data in the cache 1804 as opposed to the system memory 1803, the overall performance efficiency of the computing system improves.

System memory 1803 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 1803 prior to their being operated upon by the one or more processor(s) 1801 in the implementation of a software program. Similarly, data that a software program determines should be sent from the computing system to an outside entity through one of the computing system interfaces, or stored into an internal storage element, is often temporarily queued in system memory 1803 prior to its being transmitted or stored.

The ICH 1805 is responsible for ensuring that such data is properly passed between the system memory 1803 and its appropriate corresponding computing system interface (and internal storage device if the computing system is so designed). The MCH 1802 is responsible for managing the various contending requests for system memory 1803 access amongst the processor(s) 1801, interfaces and internal storage elements that may proximately arise in time with respect to one another.

One or more I/O devices 1808 are also implemented in a typical computing system. I/O devices generally are responsible for transferring data to and/or from the computing system (e.g., a networking adapter); or, for large scale non-volatile storage within the computing system (e.g., hard disk drive). ICH 1805 has bi-directional point-to-point links between itself and the observed I/O devices 1808.

It is believed that processes taught by the discussion above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a .NET environment, a Windows/NT environment each provided by Microsoft Corporation).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
calculating, by processing software program code on a computer, wireless signal coverage within a building for each of multiple floors within said building, said calculating comprising accounting for outdoor signal coverage, accounting for building height, accounting for external building wall material and accounting for internal building wall material.

2. The method of claim 1 wherein said accounting for external building wall material and accounting for internal building wall material further comprises generating building loss values at internal and external walls of said building.

3. The method of claim 2 wherein said accounting for building height further comprises applying building penetration loss adjustments for floors above ground level.

4. The method of claim 3 further comprising, after said accounting for outdoor signal coverage, accounting for building height, accounting for external building wall material and accounting for internal building wall material, converting a representation of building loss values from vector form to raster form.

5. The method of claim 1 further comprising presenting an image of said wireless signal coverage within said building on a computing system display.

6. The method of claim 1 wherein said calculating further comprises approximating inner walls within said building with concentric contours fit within a shape of said building's outer wall.

7. The method of claim 1 wherein said accounting for building height causes a reduction in said wireless signal coverage within said building moving upward in said building above said building's twelfth floor.

8. The method of claim 1 wherein said accounting for building height causes an increase in said wireless signal coverage within said building moving upward in said building between said building's second floor and twelfth floor.

9. The method of claim 1 wherein said outdoor signal coverage is expressed by at least one of the following:
received signal strength;
received signal quality;
frame error rate.

10. The method of claim 1 wherein said accounting of outdoor signal strength includes both measured data and information from a prediction grid.

11. A method, comprising:
planning, by processing software program code on a computer, node upgrades to a wireless networking service, said planning including:
calculating outdoor node cost as a function of in building wireless network service coverage;
calculating indoor node cost as a function of in building wireless network coverage;
identifying an in building wireless network coverage value where said outdoor node cost equals said indoor node cost;
recommending addition of an outdoor node because current coverage is less than said value; and,
recommending addition of an indoor node because current coverage is greater than said value.

12. The method of claim 11 wherein said in building wireless network coverage is specified with at least one of the following:
received signal strength;
received signal quality;
frame error rate;
usage time;
dropped calls.

13. The method of claim 11 wherein said indoor node cost is calculated per unit area of in building coverage.

14. The method of claim 11 wherein average building size is used as a basis for said calculating of said indoor node cost.
